(19) United States
(12) Patent Application Publication
(10) Pub. No.: US 2009/0126394 A1
(43) Pub. Date: May 21, 2009

(54) PORTABLE COOLER

(76) Inventor: TORBEN KROG, Herning (DK)

Correspondence Address: Baker & Hostetler LLP;Attn: Jim Coffman, 45 Rockefeller Plaza, New York, NY, 10111, US

(21) Appl. No.: 12/107,587

(22) Filed: Apr. 22, 2008

Related U.S. Application Data
(60) Provisional application No. 60/989,657, filed on Nov. 21, 2007.

(51) Int. Cl. B67D 5/62; B65D 21/00

(52) U.S. Cl. 62/399; 62/457.2; 206/511

(57) ABSTRACT

A portable cooler for storing and cooling beverage(s) and/or food product(s) comprising a hollow main compartment, a lid assembly for closing the hollow main compartment and a spout assembly extending from the hollow main compartment for discharging stored liquid product wherein said lid assembly includes an independent storage compartment for dry food product and wherein said hollow main compartment includes a body with at least one protrusion forming a coupling member for removably attaching at least one block of stored coolant adapted to be pre-refrigerated before liquid product is stored into the hollow main compartment of the portable cooler.

### FIELD OF THE INVENTION

This invention relates in general to the field of portable coolers to store and cool liquid beverages and dry products and more particularly to a portable cooler having a main storage compartment for storing and cooling liquid beverages and a dry storage compartment for independently storing and cooling dry products with the portable cooler having a temperature control insert permitting the stored liquid product to be discharged at a temperature below the storage temperature within the storage compartment and having nesting feet for forming a stacked arrangement to facilitate the transportation of a large number of such portable coolers in a single shipping container.

### BACKGROUND OF THE INVENTION

Most conventional portable coolers depend upon the user placing a refrigerated coolant, such as refrigerated ice cubes, into the storage compartment of the cooler to control the storage temperature of the stored product. The coolant must be physically placed adjacent to or as close as possible to the stored product(s) to be effective. However, ice cubes when added to the cooler will dilute a liquid beverage not separately packaged and when the ice cubes melt a messy environment is created inside the storage compartment which requires cleaning. In addition, the number of ice cubes needed for cooling limit the available space to store product.

A portable cooler typically includes thermal insulating material(s) but otherwise relies upon the user either placing refrigerated ice cubes or a pre-refrigerated coolant into the storage compartment to keep the product cool or placing a combination of chemical compounds into the storage compartment which will represent a static source of energy when activated. However, the arbitrary placement of a pre-refrigerated coolant into the storage compartment does not provide homogeneous cooling of stored product and, as indicated above, the placement of ice cubes will dilute a liquid beverage not separately packaged. Liquid beverages particularly soda and beer must be discharged from the cooler at a low temperature to satisfy the demands of the typical consumer.

Accordingly, there is a large marketplace for portable coolers which can be used to store and cool liquid beverages and optionally to store food products of different type independent of the storage of liquid beverages. The portable cooler should include a spout to dispense liquid beverage from the cooler and should dispense the liquid beverage at a uniformly cold temperature without requiring an external source of energy for cooling the liquid beverage. Furthermore, to satisfy this marketplace the portable cooler must be relatively low in cost. The portable cooler must therefore be able to be transported from the source of manufacture at very low cost to the marketplace.

Prior art portable coolers contain, in general, a single compartment into which one must put all product to be stored including beverages. Moreover, the typical prior art portable cooler which contains a spout to discharge liquid beverages are not capable of lowering the temperature of the liquid beverage at or adjacent the point of discharge and as such there is such no assurance that the discharged liquid beverage will be at an adequately cold temperature. Moreover, prior art portable coolers are not stackable for ease of transportation.

The portable cooler of the present invention is designed to nest into one another so that they can be easily stacked and placed into a shipping container for transportation at low cost. In addition, the portable cooler of the present invention contains a temperature control insert which is removably placed in the portable cooler and coupled to the discharge spout for cooling the temperature of stored liquid beverage as the beverage is being discharged from the spout.

### SUMMARY OF THE INVENTION

The present invention relates to a portable cooler for storing and cooling beverage and/or food products comprising a hollow main compartment, a lid assembly for closing the hollow main compartment and a spout assembly extending from the hollow main compartment for discharging stored liquid product. The lid assembly includes an independent storage compartment for dry food product and the cooler comprises a hollow main storage compartment for storing liquid product independent of the compartment in the lid assembly. At least one sliding member comprising a sealed hollow block containing liquid coolant is stored in the sealed block of the sliding member with the sliding member in a configuration adapted to couple to a female part protruding from the interior of the hollow main storage compartment. The sliding member containing stored coolant is pre-refrigerated before it is placed in the hollow main compartment of the portable cooler.

The portable cooler preferably includes a temperature control insert which is removably mounted into the cooler at the bottom end of the hollow main storage compartment in removable engagement with the spout assembly for decreasing the temperature of stored liquid product at the point of discharge into the spout assembly. The temperature control insert contains a stored sealed coolant adapted to be pre-refrigerated before placement into the hollow main compartment of the portable cooler. The temperature control insert and the sliding member of stored coolant may be used in the cooler without the other or in combination.

The portable cooler should preferably also includes nesting feet which enables the portable cooler to nest upon another portable cooler so that they can be easily stacked and placed into a shipping container for transportation at low cost.

### BRIEF DESCRIPTION OF THE DRAWINGS

FIG. 1 is a front elevation view of the portable cooler of the present invention;

FIG. 2 is a bottom view of the portable cooler of FIG. 1;

FIG. 3(a) is another view in elevation of the portable cooler of the present invention shown rotated 180° from the position shown in FIG. 1;

FIG. 3(b) is a top view of the portable cooler of FIG. 3(a);

FIG. 4 is an exploded view in perspective of the portable cooler of FIG. 1;

FIG. 5 is a view in cross section of the portable cooler of FIG. 3(b) taken along the lines 5-5;

FIG. 6 is an enlarged view of the area D in FIG. 5;

FIG. 7 is an enlarged exploded view of the unassembled components of the spout assembly in the portable cooler of FIG. 5;

FIG. 8(a) is a cross sectional view of the portable cooler of FIG. 3(b) taken along the lines 8-8 with the portable cooler shown mounted over the lid assembly of another portable cooler;

FIG. 8(b) is an enlarged view of the area Y in FIG. 8(a);

FIG. 9 is an enlarged view of the area E in FIG. 8(a);

FIG. 10 is an enlarged view of the area F in FIG. 8(a);

FIG. 11 is an exploded perspective view of the lid assembly 20 in the portable cooler of FIG. 1;

FIG. 12 is yet another view in elevation of the portable cooler of the present invention shown rotated 90° from the position shown in FIG. 1;

FIG. 13 is a cross sectional view along the lines z-z of FIG. 12;

FIG. 14 is a perspective view of the temperature control insert 6 of FIG. 4 shown upside down;

FIG. 15 is a cross sectional view of the portable cooler of FIG. 1 taken along the lines 0-0;

FIG. 16 is a cut away in perspective of the portable cooler of FIG. 8(a) with the lid assembly removed;

FIG. 17(a) is a perspective view of one of the sliding members of stored of coolant;

FIG. 17(b) is a front view of the sliding member of stored coolant shown in FIG. 17(a);

FIG. 17(c) is an end view of the sliding member of stored coolant shown in FIG. 17(a); and

FIG. 18 is a partially exploded perspective view of the body of the portable cooler of FIG. 1 with the lid assembly removed.

### DETAILED DESCRIPTION OF THE PREFERRED EMBODIMENT OF THE INVENTION

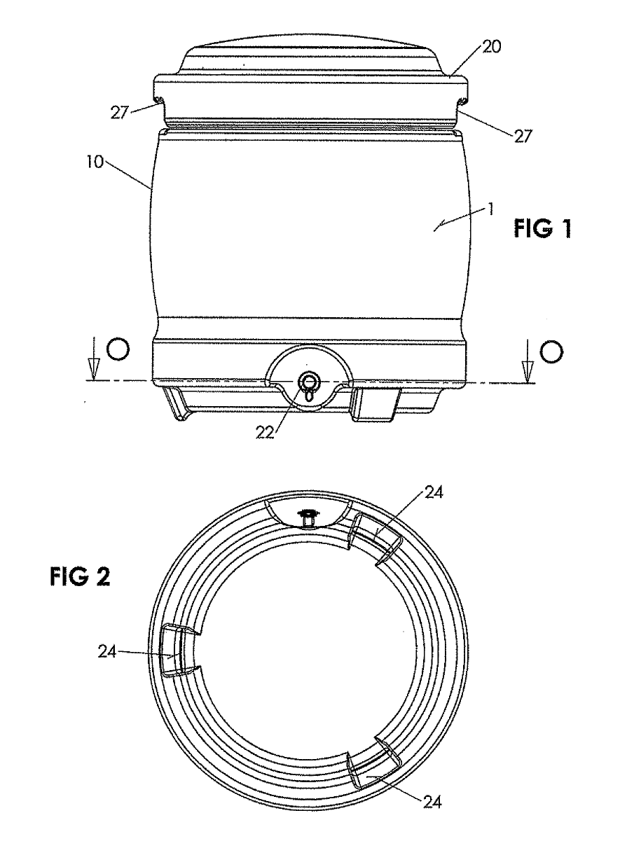

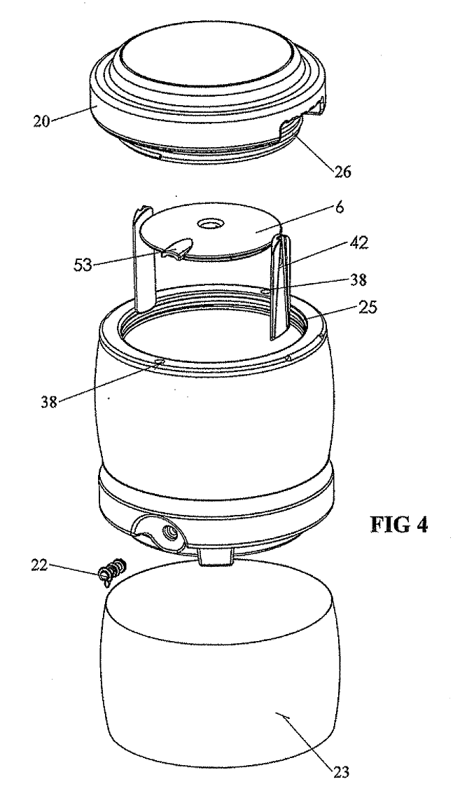

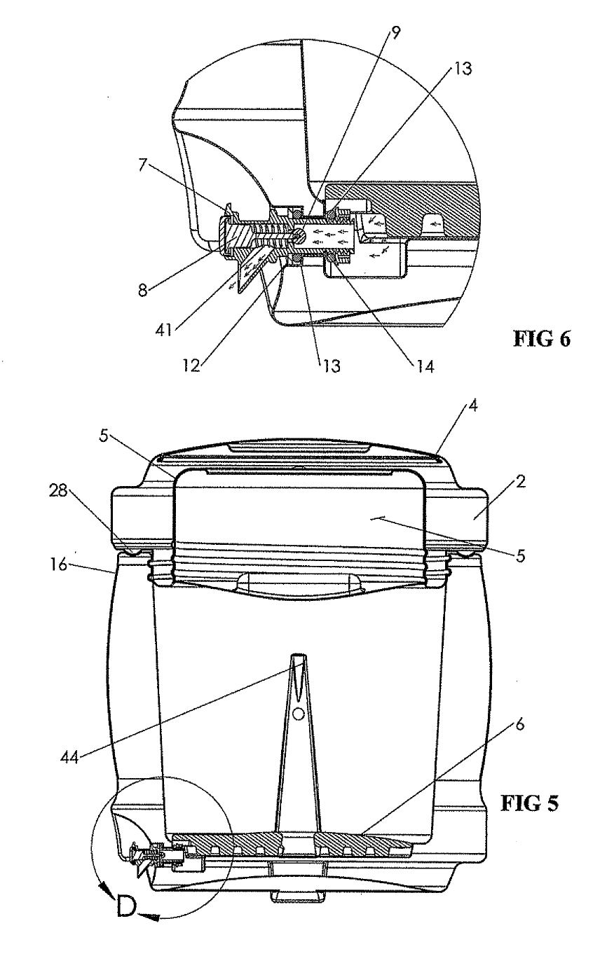

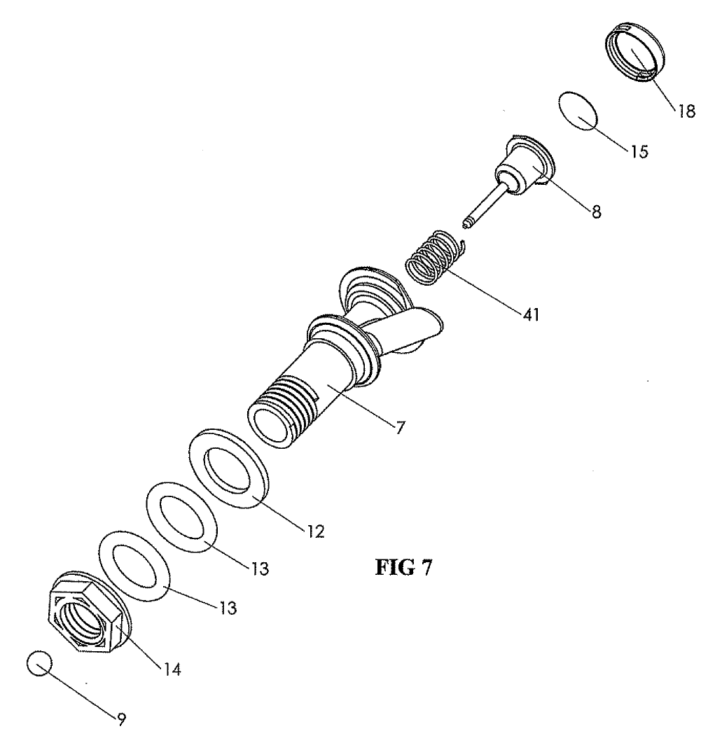

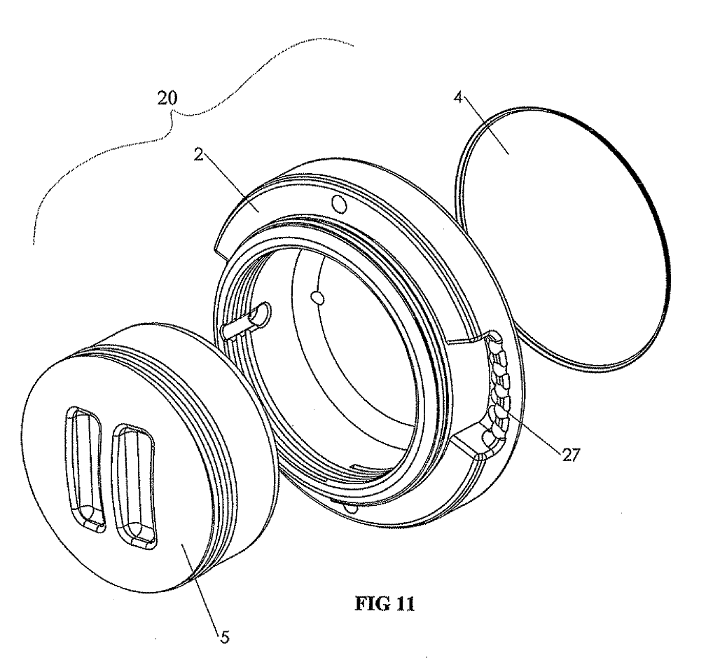

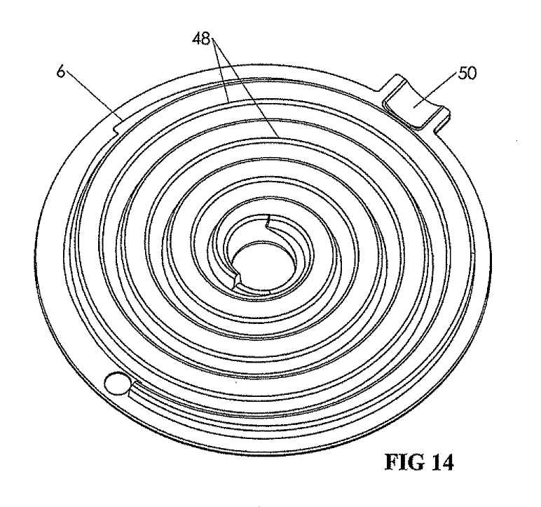

The preferred embodiment of the portable cooler 10 of the present invention is illustrated in FIGS. 1-18 inclusive with the portable cooler 10 comprising a body 1, a lid assembly 20, a removable temperature control insert 6, a spout assembly 22, removable sliding blocks of stored coolant 42 and nesting feet 24. The body 1 is hollow forming an internal storage compartment 40 with the body 1 preferably being cylindrical or barrel shaped although it may be in any desired geometrical configuration. A band 23 as shown in FIG. 4 slips over the center portion of the body 1 and may have a brand name on the outside of the band 23 so that when the band 23 is fitted over the portable cooler 10 the band 23 provides advertising for a liquid beverage stored in the cooler 10. The body 1 has internal threads 25 located at the upper end thereof and the lid assembly 20 has corresponding external threads 26 so that the lid assembly 20 may be threaded into the main body 1. The lid assembly 20 is composed of a removable lid 2 with a handle grip 27 at two opposite ends of the lid assembly 20 for a user to hold the portable cooler 10 and has a dry internal compartment 5. The internal compartment 5 is intended for the storage of fresh dry goods including, for example, snacks, candy cheese etc. to be stored separate from the storage of product in the main body 1. The internal compartment 5 is accessed by taking off the lid 2. Moreover, the internal compartment 5 is threadably inserted into the lid assembly 20 and contains a gasket 21 (see FIG. 9) under the top part of the internal compartment 5 to keep the interior of the internal compartment 5 both waterproof and pressure proof.

Dimples 38 are provided around the circumference of the main body 1 to provide a positive lock when the lid assembly 20 is threaded into the main body 1. The lid assembly 20 should preferably include double threads 28 and 29 as shown in Figure and the dry internal compartment 5 should also have threads 30 and 31 to permit the dry internal compartment 5 to be removably attached to the lid assembly 20. In addition the dry internal compartment 5 should include a positive stop 32 to lock in the dry goods compartment when attached to the lid assembly 20. A removable decal 33 is adapted to fit into the top of the lid assembly 20 for further branding of advertisement material.

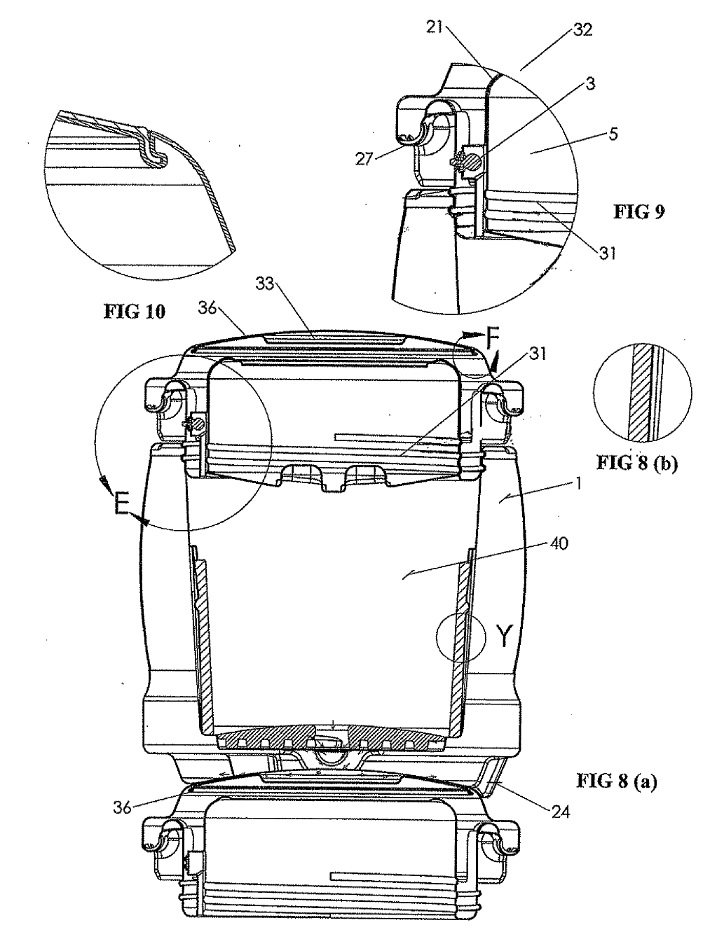

A plurality of nesting feet 24 extend from the bottom of the main body 1 as shown in FIGS. 1, 2 and 3 and are inclined at an angle relative to the vertical to enable the nesting feet to be securely mounted upon a ridge 36 surrounding the lid assembly 20 to enable one portable cooler 10 to nest upon another for forming a stacked arrangement as shown in FIG. 8(a). This facilitates the transportation of a multiple number of portable coolers 10 into a shipper container for distribution to local retail distributors worldwide as well as in a retail store. Accordingly shipping cost as well as handling charges are significantly reduced.

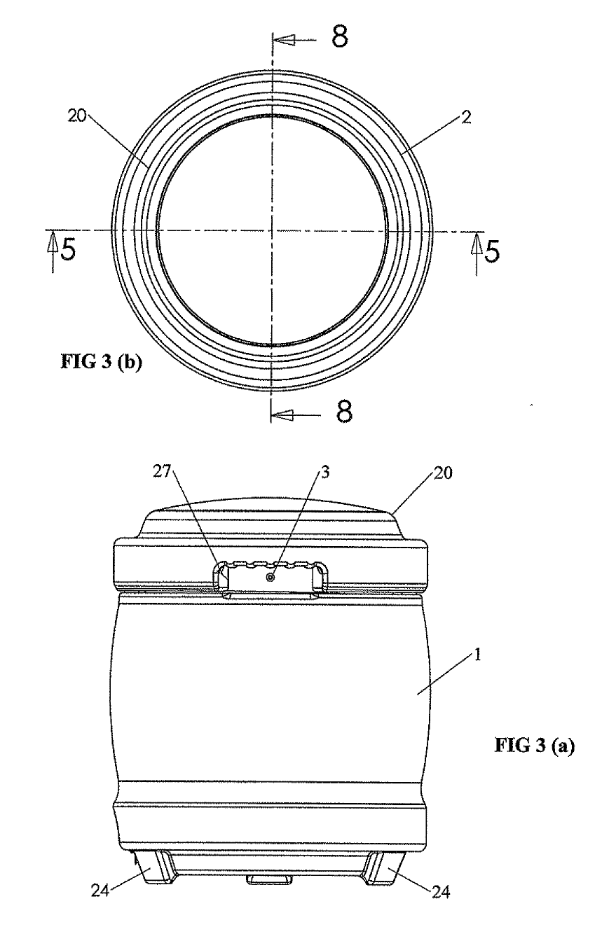

The main body 1 of the portable cooler 10 is hollow thereby forming a main storage compartment 40 in the main body 1 of the portable cooler 10 for the storage of a liquid beverage. A pressure relief valve 3 in the lid assembly 20 as shown in FIGS. 3(a) and 9 communicates with the main storage compartment 40 and extends to the atmosphere which enables a user to relieve internal pressure in the portable cooler 10 particularly when carbonated liquid beverage is being stored in the cooler. The main storage compartment 40 is coupled to the spout assembly 22 at the bottom end of the main storage compartment 40 for discharging liquid beverage stored in the main storage compartment 40. The spout assembly 22 as is shown in FIGS. 5, 7 and 8 includes a spout button 8, a spring 41, a spout 7, a nut 14, O-rings 13, a decal 15, a washer 12. a ball 9 and a collar 18. The spout assembly 22 is substantially of conventional design and controls the discharge of beverage by a user upon depressing the spout button 8.

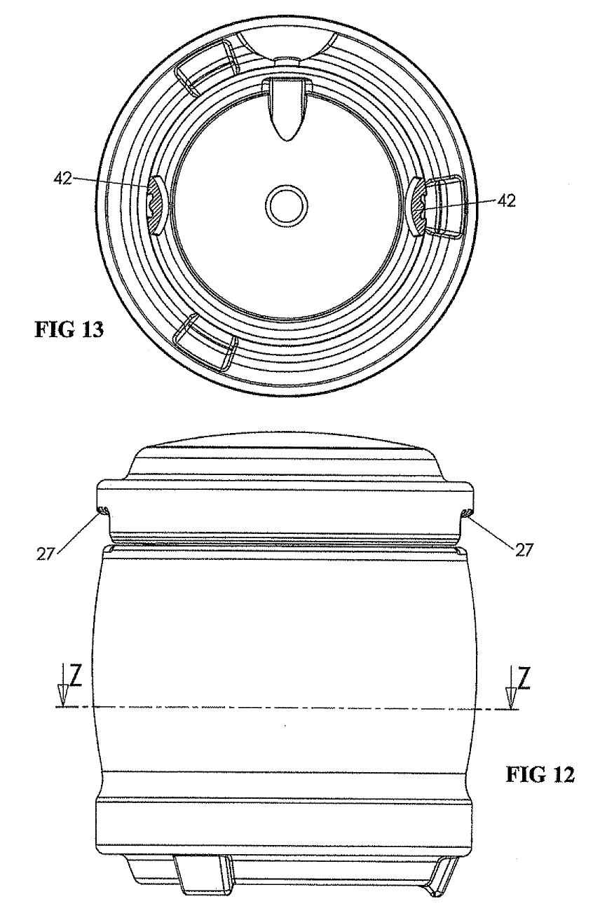

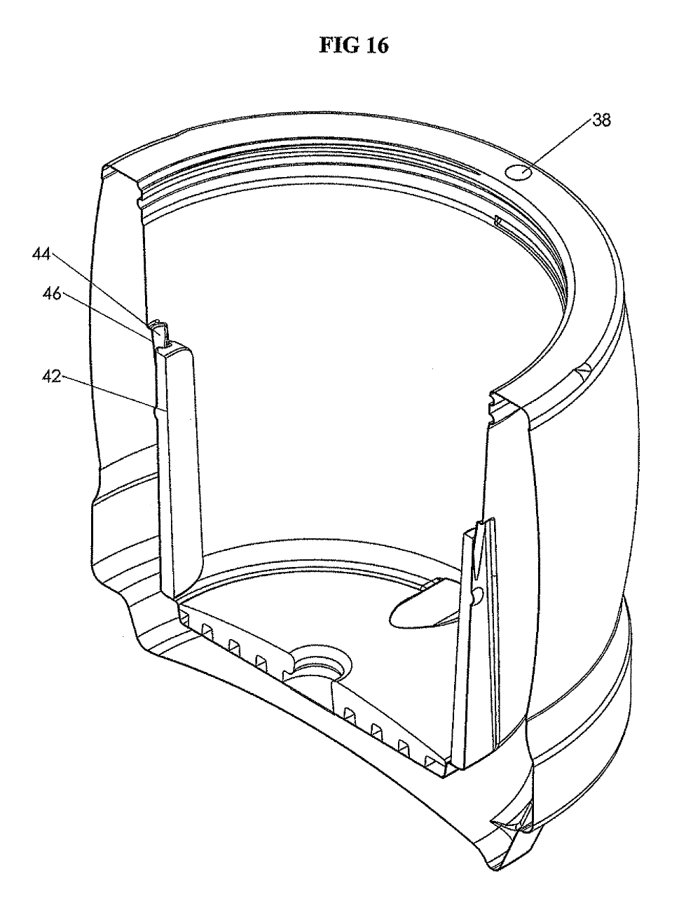

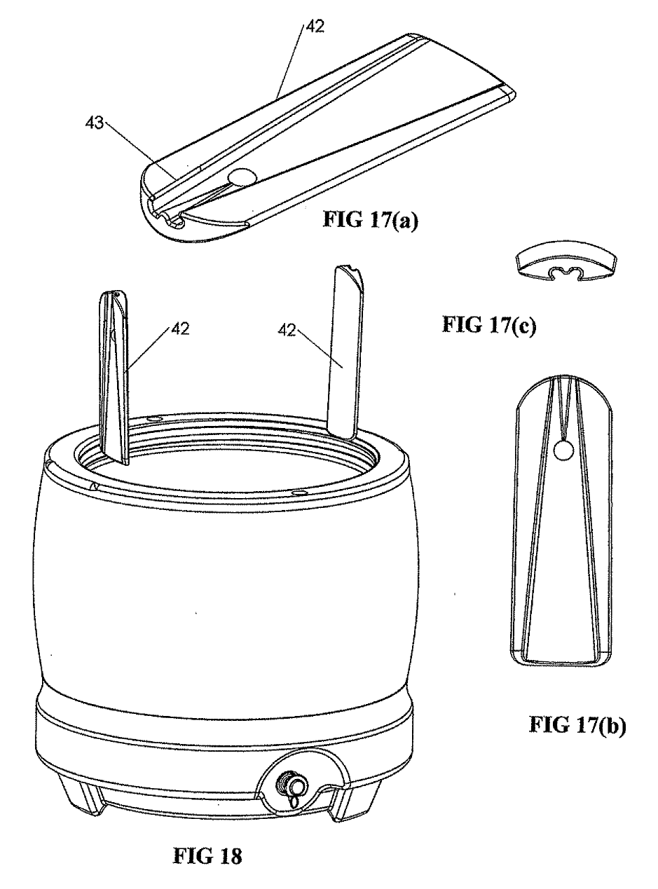

The main storage compartment 40 in the portable cooler 10 may be cooled using pre-refrigerated sliding members 42 as shown in FIG. 4 each of which are sealed blocks containing a stored liquid coolant. The coolant stored in the pre-refrigerated members 42 may be demineralized water or another cooling liquid which is sealed and pre-refrigerated before the members are mounted in the storage compartment 40 of the main body 1. The pre-refrigerated members 42 of coolant are in a configuration as shown in FIG. 17(a) having a male part 43 into which a coolant is pre-filled and sealed. The sealed male part 43 is of a configuration which enables the pre-refrigerated members 42 to be removably coupled to the storage compartment 40 preferably by sliding each of the members 42 into a counterpart female member 44 which protrudes from the inside surface of the storage compartment 40 as shown in FIG. 16. In the preferred configuration the female member 44 has a curvature with the top end thereof being in a C like geometry in a counterpart configuration to the curvature of the male part 43 so that they form a removable coupling. The pre-refrigerated members 42 may be mounted at spaced intervals apart from one another around the interior of the storage compartment 40 with each male part 43 preferably configured with a recess or groove 45 having an inverted dovetail geometry which terminates in an inverted W configuration as shown in FIG. 17(c) the sides of which are curved to permit the male part 43 to readily slide over and engage the female part 44. The male part 43 is also readily removable from the female part 43 for pre-refrigeration. The female part 44 has a detent 46 into which the male part 44 snaps which holds the male part 43 secure until the male part 44 is snapped out. A similar member 49 consisting of a sealed block of coolant is located in the dry internal compartment 5 of the lid assembly 20 as is shown in FIG. 11. The block of coolant 49 may be of a similar configuration to the slidable cooling member 42 but need not be. The internal compartment 5 has a counterpart female part (not shown) adapted to permit the block of coolant 49 to slidably engage the female part (not shown) in the lid assembly 20 so that the block of coolant 49 may be readily removed for refrigeration and removably replaced in the dry internal compartment 5.

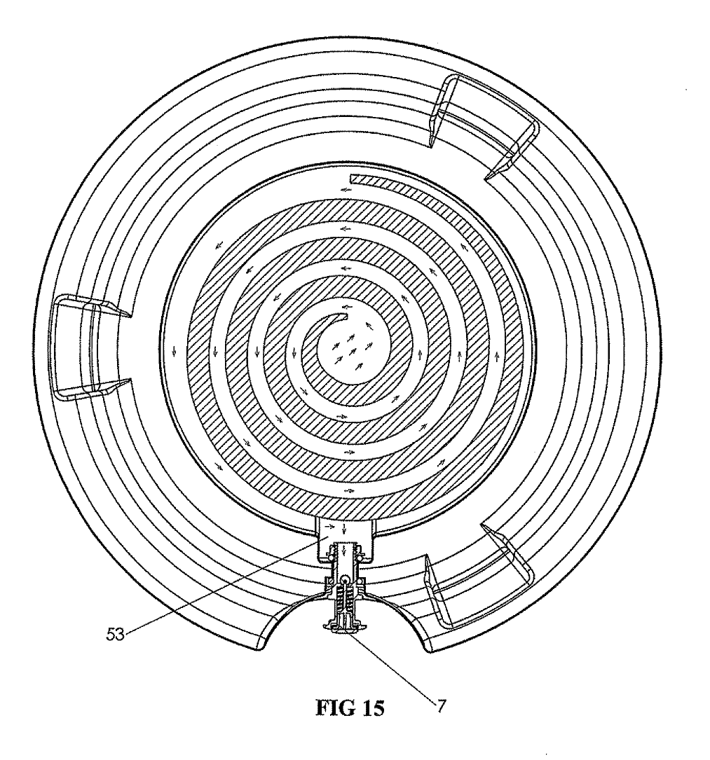

A temperature control insert 6 is shown in FIGS. 4, 5, 6 and 14-16 respectively for removable attachment at the bottom end of the main storage compartment 40 of the main body 1 of the portable cooler 10. The temperature control insert 6 comprises a sealed hollow body filled with a liquid coolant similar to the filled liquid coolant stored in the pre-refrigerated members 42 for pre-refrigeration before the temperature control insert 6 is inserted into the main storage compartment 40. The temperature control insert 6 contains multiple swirl passageways 48 in a helical configuration as shown in FIGS. 14 and 15 with an inlet end 50 through which stored liquid beverage enters from the storage compartment 40 of the portable cooler. The liquid beverage stored in the cooler follows a convoluted swirling path defined by the swirl passageways 48 from the inlet 50 to an exit keyway 53 which couples the temperature control insert 6 to the spout assembly 22 for discharge through the spout 7 upon manually depressing the spout button 8. The swirl passageways 48 in the temperature control insert 6 provide a large surface area for the pre-refrigerated coolant to enable the liquid beverage to undergo further cooling as it flows around the swirl passageways 48 before exiting the spout assembly 22. Demineralized water or another liquid coolant may be stored in the temperature control insert 6 and pre-refrigerated to lower the temperature of the liquid beverage as it flows through the temperature control insert 6 so that at the point of discharge the liquid beverage will be colder than the temperature of the liquid beverage stored in the main storage compartment 40. Accordingly, the temperature control insert 6 chills down the liquid beverage as it is being discharged from the portable cooler 10. the twisting and turning of the liquid beverage through the swirling passageways 48 causes a transfer of heat out of the liquid beverage which chills it. The swirl passageways function as coils for heat transfer. The number of turns, the pitch and the surface area will control the degree of heat transfer and the number of degrees the liquid beverage will be cooled before discharge through the spout assembly 22.

Although the main storage compartment 40 in the main body 1 of the portable cooler 10 may be filled with any desired liquid beverage such as soda, beer or wine etc. for discharge through the spout 7 the portable cooler 10 may alternatively use the main storage compartment 40 for placement of independent cans of soda or beer etc. and ice cubes may be used independent of the pre-refrigerated blocks of coolant 42 in which case the blocks of coolant 42 may be removed or used in combination with ice cubes. If a liquid beverage is not being stored in the portable cooler 10 the temperature control insert 6 may also be removed from the portable cooler 10 or may be used for additional cooling of stored product in the main storage compartment 40.

I claim:

1. A portable cooler for storing and cooling beverage(s) and/or food product(s) comprising a hollow main storage compartment adapted to store liquid product, a lid assembly for closing the hollow main storage compartment and a spout assembly extending from the hollow main storage compartment for discharging liquid product from the hollow main compartment, wherein said lid assembly includes a storage compartment for storing dry food product independent of the liquid product stored in the hollow main storage compartment and further comprising at least one sealed hollow member containing a sealed coolant removably mounted in said hollow main storage compartment for cooling the stored liquid product.

2. A portable cooler as defined in claim 1 further comprising at least one female member protruding from the hollow main storage compartment with said at least one sealed hollow member in a configuration to slidably engage the female member and to be removable there from for pre-refrigeration of the sealed coolant.

3. A portable cooler as defined in claim 2 further comprising a temperature control insert mounted at the bottom of said hollow main storage compartment and coupled to said spout assembly for cooling the stored liquid product at the point of discharge form said spout assembly,

4. A portable cooler as defined in claim 3 wherein said temperature control insert comprises swirl passageways forming a convoluted swirling path for passage of the stored liquid product before discharge from the spout assembly.

5. A portable cooler as defined in claim 4 further comprising a plurality of nesting feet extending from said portable cooler adapted for mounting upon another portable cooler to form a stacked arrangement to facilitate the transportation of a large number of such portable coolers in a single shipping container.

6. A portable cooler for storing and cooling beverage(s) and/or food product(s) comprising a hollow main compartment, a lid assembly for closing the hollow main compartment, a spout assembly extending from the hollow main compartment for discharging stored liquid product from the hollow main compartment and a temperature control insert removably inserted into the hollow main compartment to engage the spout assembly for decreasing the temperature of the stored liquid product as it is being discharged from the spout assembly with the temperature control insert containing a stored coolant adapted to be pre-refrigerated before placement into the hollow main compartment of the portable cooler.

7. A portable cooler as defined in claim 6 wherein said temperature control insert comprises swirl passageways forming a helical configuration for passage of the stored liquid product from the hollow main storage compartment before discharge from the spout assembly.

8. A portable cooler as defined in claim 7 further comprising one or more sealed hollow members each containing a sealed coolant removably mounted in said hollow main storage compartment for cooling the stored liquid product.

9. A portable cooler as defined in claim 8 further comprising an equal number of one or more female members protruding from the hollow main storage compartment for each one of said sealed hollow members with each sealed hollow member in a configuration to slidably engage a counterpart female member and to be removable there from for pre-refrigeration of the sealed coolant in the sealed hollow member.

10. A portable cooler as defined in claim 9 further comprising a plurality of nesting feet extending from said portable cooler adapted for mounting upon another portable cooler to form a stacked arrangement to facilitate the transportation of a large number of such portable coolers in a single shipping container.
